(19) United States
(12) Patent Application Publication
(10) Pub. No.: US 2023/0252422 A1
(43) Pub. Date: Aug. 10, 2023

(54) CONNECTION SYSTEM, SERVICE PROVIDER SYSTEM, EMPLOYMENT PROVIDER SYSTEM, SELF-EMPLOYMENT SYSTEM, HOURLY CONTRACTING SYSTEM, AND METHODS OF USE

(71) Applicant: Ivan Murillo, Sante Fe, TX (US)

(72) Inventor: Ivan Murillo, Sante Fe, TX (US)

(21) Appl. No.: 18/102,711

(22) Filed: Jan. 28, 2023

Related U.S. Application Data
(60) Provisional application No. 63/308,540, filed on Feb. 10, 2022.

(51) Int. Cl. G06Q 10/1053

(52) U.S. Cl. CPC G06Q 10/1053

(57) ABSTRACT

A connection system for connecting those in need of services or equipment to those providing services and/or equipment system, process, and method of use are presented. The system is provided to connect service providers offering hourly services to clients in need of hourly services. Furthermore, the present system provides for connecting equipment ownership and rental on an hourly basis. The present disclosure connects those which have needs of hourly services to those offering hourly services by unique sorting which better connects those with a need to those offering services on a geographical basis and job need.

### CROSS-REFERENCE TO RELATED APPLICATIONS

The present application claims priority to the U.S. Provisional Patent Application No. 63/308,540 which was filed on Feb. 10, 2022, which is hereby incorporated by reference herein in its entirety, including any figures, tables, or drawings.

### FIELD OF THE DISCLOSURE

This disclosure relates to a connection system for connecting those in need of services or equipment to those providing services and/or equipment. More specifically, and without limitation, the present disclosure relates to a system for hourly and/or daily contracting from individuals to individuals and/or groups to individuals. More specifically, and without limitation, the present disclosure relates to providing rental services of equipment on hourly, daily, weekly, monthly, or yearly basis. More specifically, and without limitation, the present disclosure relates to an employment opportunity system and methods of use.

### COPYRIGHT NOTICE

At least a portion of the disclosure of this patent document contains material that is subject to copyright protection. The copyright owner has no objection to the facsimile reproduction by anyone of the patent document or the patent disclosure, as it appears in the Patent and Trademark Office patent files and/or records, but otherwise reserves all copyright rights whatsoever. The following notice applies to the software and data as described below and in the drawings that form a part of this document. Copyright. Ivan Murillo. All rights reserved.

### BACKGROUND OF THE DISCLOSURE

In recent times, freelancing and employment oriented online service organizations have grown in number on websites and mobile applications. Various platforms have emerged in the art which provide benefits and services for use in employment opportunities. Some of these benefits and/or platforms are used for professional networking and career development. Still other platforms and services allow job seekers to post resumes and CVs. Still further, some of these platforms and/or other platforms allow employers to post jobs.

In this way, various employment and/or business platforms in the state of the art provide for members of those platforms, both workers and employers, to start an account, manage a profile associated with that account, and then connect with others. In this way, some of these platforms function as online networking allowing businesses and employees and professionals to network with other businesses and professionals.

Furthermore, many employment platforms have emerged which focus more on helping professionals find employment, while also helping businesses hire professionals. In this way, members, or professionals, can also create accounts, manage their profiles, upload information such as resumes, and the like.

Current websites and platforms are well known in the state of the art in offering connections for professionals to professionals, businesses to businesses, and even can aid in connecting professionals to employment opportunities and/or aid in providing businesses opportunities to find and employ professionals. Additionally, some of these platforms allow for organization of online and offline events, joining groups related to a particular profession or interest, writing articles about topics in a given profession and subsequently publishing those articles, creating and publishing job postings, publishing photos related to a profession or outreach program, video posting, and more.

Most of the existing state of the art is directed to professionals looking for professional work with businesses. Other platforms do a great job of helping professionals connect with other professionals in similar professions. Still further some of these platforms, and others, help businesses find professionals for employment. The networks, thus created and existing in the state of the art, have introduced platforms for professionals and businesses to connect and share. However, the existing platforms fail to provide a connection for individuals looking for temporary or permanent services, whether a singular type of task and/or job or a regular type of task and/or job. Furthermore, these existing platforms fail to provide an easy way for any individual to offer services as a self-employed professional and/or rent out equipment and/or offer services associated with equipment rental.

Thus, there is a long-felt need in the art for a connection service between an individual and another individual for a first individual to provide a service and/or a rental of equipment. In this way, a platform is needed which truly allows any individual to become their own boss. Furthermore, there is a need for a platform which provides an opportunity for anyone to rent equipment and/or provide group services and/or provide services related to equipment rental, and the like.

The disclosure herein provides these advantages and others as will become clear from the specification and claims provided.

### SUMMARY OF THE DISCLOSURE

A connection system for connecting those in need of services or equipment to those providing services and/or equipment, process, and method of use are presented. More specifically, and without limitation, the present disclosure relates to a system for hourly and/or daily contracting from individuals to individuals and/or groups to individuals. More specifically, and without limitation, the present disclosure relates to providing rental services of equipment on hourly, daily, weekly, monthly, or yearly basis. More specifically, and without limitation, the present disclosure relates to an employment opportunity system and methods of use.

Thus, it is a primary object of the disclosure to provide a connection system, a service provider connection system, an employment system, an hourly contracting system, and methods of use that improves upon the state of the art.

Another object of the disclosure is to provide a connection system, a service provider connection system, an employment system, an hourly contracting system, and methods of use that provides a platform in which any person in the world can become their own boss.

Yet another object of the disclosure is to provide a connection system, a service provider connection system, an employment system, an hourly contracting system, and methods of use that provides a search engine for any type of service offering.

Another object of the disclosure is to provide a connection system, a service provider connection system, an employment system, an hourly contracting system, and methods of use that provides a search engine for any type of equipment offering.

Yet another object of the disclosure is to provide a connection system, a service provider connection system, an employment system, an hourly contracting system, and methods of use that provides a platform for practicing any type of profession.

Another object of the disclosure is to provide a connection system, a service provider connection system, an employment system, an hourly contracting system, and methods of use that provides a platform for advertising any profession.

Yet another object of the disclosure is to provide a connection system, a service provider connection system, an employment system, an hourly contracting system, and methods of use that provide customized pricing and service offerings.

Another object of the disclosure is to provide a connection system, a service provider connection system, an employment system, an hourly contracting system, and methods of use that provide for hourly service offerings.

Yet another object of the disclosure is to provide a connection system, a service provider connection system, an employment system, an hourly contracting system, and methods of use that provide for daily service offerings.

Another object of the disclosure is to provide a connection system, a service provider connection system, an employment system, an hourly contracting system, and methods of use that provide for monthly service offerings.

Yet another object of the disclosure is to provide a connection system, a service provider connection system, an employment system, an hourly contracting system, and methods of use that provide for weekly service offerings.

Another object of the disclosure is to provide a connection system, a service provider connection system, an employment system, an hourly contracting system, and methods of use that provide for yearly offerings.

Yet another object of the disclosure is to provide a connection system, a service provider connection system, an employment system, an hourly contracting system, and methods of use that do not have time limits.

Another object of the disclosure is to provide a connection system, a service provider connection system, an employment system, an hourly contracting system, and methods of use that do not limit the type of professional services to a single type of service offering.

Yet another object of the disclosure is to provide a connection system, a service provider connection system, an employment system, an hourly contracting system, and methods of use that provide a profile creation platform and provide for multiple different profiles.

Another object of the disclosure is to provide a connection system, a service provider connection system, an employment system, an hourly contracting system, and methods of use that utilizes facial recognition.

Yet another object of the disclosure is to provide a connection system, a service provider connection system, an employment system, an hourly contracting system, and methods of use that utilizes facial recognition to limit tampering.

Another object of the disclosure is to provide a connection system, a service provider connection system, an employment system, an hourly contracting system, and methods of use that prevent bad profiles being hidden from potential clients.

Yet another object of the disclosure is to provide a connection system, a service provider connection system, an employment system, an hourly contracting system, and methods of use that provide a referral network.

Another object of the disclosure is to provide a connection system, a service provider connection system, an employment system, an hourly contracting system, and methods of use that provide client feedback systems.

Yet another object of the disclosure is to provide a connection system, a service provider connection system, an employment system, an hourly contracting system, and methods of use that provide an escrow system.

Another object of the disclosure is to provide a connection system, a service provider connection system, an employment system, an hourly contracting system, and methods of use that provide a mediation system.

Yet another object of the disclosure is to provide a connection system, a service provider connection system, an employment system, an hourly contracting system, and methods of use that provide a system for lead generation.

Another object of the disclosure is to provide a connection system, a service provider connection system, an employment system, an hourly contracting system, and methods of use that utilizes global positioning to connect services and clients based on location.

Yet another object of the disclosure is to provide a connection system, a service provider connection system, an employment system, an hourly contracting system, and methods of use that utilizes geo-fencing.

Another object of the disclosure is to provide a connection system, a service provider connection system, an employment system, an hourly contracting system, and methods of use that utilizes geographic location of service and/or equipment offerings.

Yet another object of the disclosure is to provide a connection system, a service provider connection system, an employment system, an hourly contracting system, and methods of use that utilizes a circumference or mile range for service offerings.

Another object of the disclosure is to provide a connection system, a service provider connection system, an employment system, an hourly contracting system, and methods of use that utilizes a particular rating system.

Yet another object of the disclosure is to provide a connection system, a service provider connection system, an employment system, an hourly contracting system, and methods of use that allows clients to rate providers.

Another object of the disclosure is to provide a connection system, a service provider connection system, an employment system, an hourly contracting system, and methods of use that allows clients to rate equipment based on newness and condition.

Yet another object of the disclosure is to provide a connection system, a service provider connection system, an employment system, an hourly contracting system, and methods of use that allows a service provider to set a minimum and/or a minimum number of hours.

Another object of the disclosure is to provide a connection system, a service provider connection system, an employment system, an hourly contracting system, and methods of use that eliminates the middle person.

Yet another object of the disclosure is to provide a connection system, a service provider connection system, an employment system, an hourly contracting system, and methods of use that require approval from clients for additional people or approval of more than one person in advance.

Another object of the disclosure is to provide a connection system, a service provider connection system, an employment system, an hourly contracting system, and methods of use that provide the ability to start a business.

Yet another object of the disclosure is to provide a connection system, a service provider connection system, an employment system, an hourly contracting system, and methods of use that provide the ability to offer a service in spare time or at particular times of the day and/or on particular days of the week.

Another object of the disclosure is to provide a connection system, a service provider connection system, an employment system, an hourly contracting system, and methods of use that provide for uploading particular certifications.

Yet another object of the disclosure is to provide a connection system, a service provider connection system, an employment system, an hourly contracting system, and methods of use that build relationships.

Another object of the disclosure is to provide a connection system, a service provider connection system, an employment system, an hourly contracting system, and methods of use that tracks historical data.

Yet another object of the disclosure is to provide a connection system, a service provider connection system, an employment system, an hourly contracting system, and methods of use that provide alerts.

Another object of the disclosure is to provide a connection system, a service provider connection system, an employment system, an hourly contracting system, and methods of use that provide a communication platform.

Yet another object of the disclosure is to provide a connection system, a service provider connection system, an employment system, an hourly contracting system, and methods of use that are easy to use.

Another object of the disclosure is to provide a connection system, a service provider connection system, an employment system, an hourly contracting system, and methods of use that are safe to use.

Yet another object of the disclosure is to provide a connection system, a service provider connection system, an employment system, an hourly contracting system, and methods of use that are accurate.

Another object of the disclosure is to provide a connection system, a service provider connection system, an employment system, an hourly contracting system, and methods of use that work with various digital platforms.

Yet another object of the disclosure is to provide a connection system, a service provider connection system, an employment system, an hourly contracting system, and methods of use that provide a user interface.

Another object of the disclosure is to provide a connection system, a service provider connection system, an employment system, an hourly contracting system, and methods of use that can be used quickly and efficiently.

Yet another object of the disclosure is to provide a connection system, a service provider connection system, an employment system, an hourly contracting system, and methods of use that are robust.

Another object of the disclosure is to provide a connection system, a service provider connection system, an employment system, an hourly contracting system, and methods of use that saves time for a user.

Yet another object of the disclosure is to provide a connection system, a service provider connection system, an employment system, an hourly contracting system, and methods of use that are high quality.

These and other objects, features, or advantages of the present disclosure will become apparent from the specification and claims.

### BRIEF DESCRIPTION OF THE DRAWINGS

The drawings accompanying and forming part of this specification are included to depict certain aspects of the disclosure.

FIG. 1 is a diagram illustrating the self-employment system; the view showing one example of one embodiment of how a client may locate and hire a service provider using the system disclosed herein.

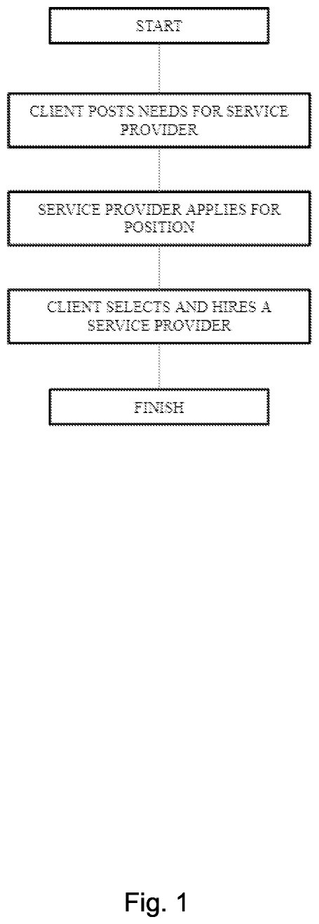

FIG. 2 is a diagram illustrating the self-employment system; the view showing one example of one embodiment of how a client may locate and hire a piece of equipment being offered by a service provider using the system disclosed herein.

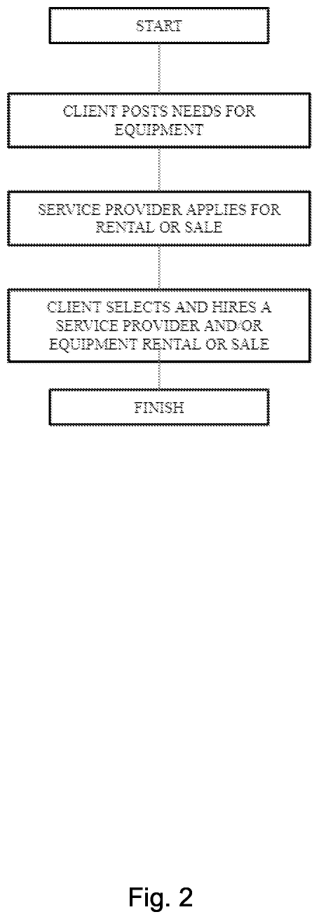

FIG. 3 is a diagram illustrating the self-employment system; the view showing one example of one embodiment of how a client and service provider may interact with the graphical user interface and/or equipment.

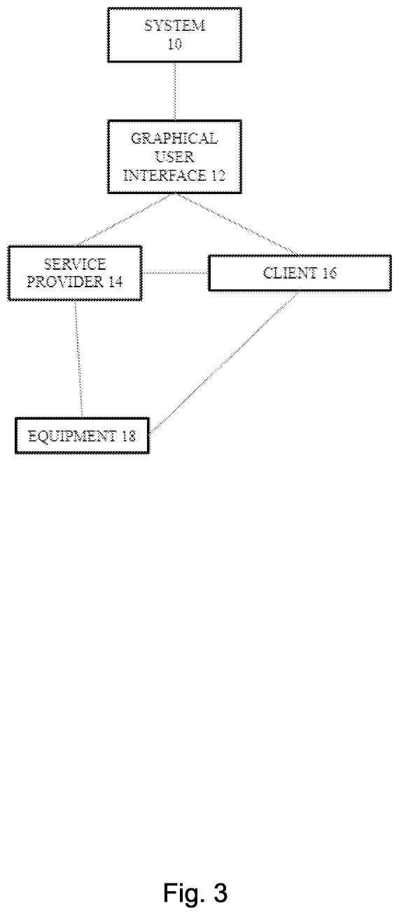

FIG. 4 is a diagram illustrating the self-employment system; the view showing one example of one embodiment of how a client and service provider may interact with the graphical user interface and/or equipment.

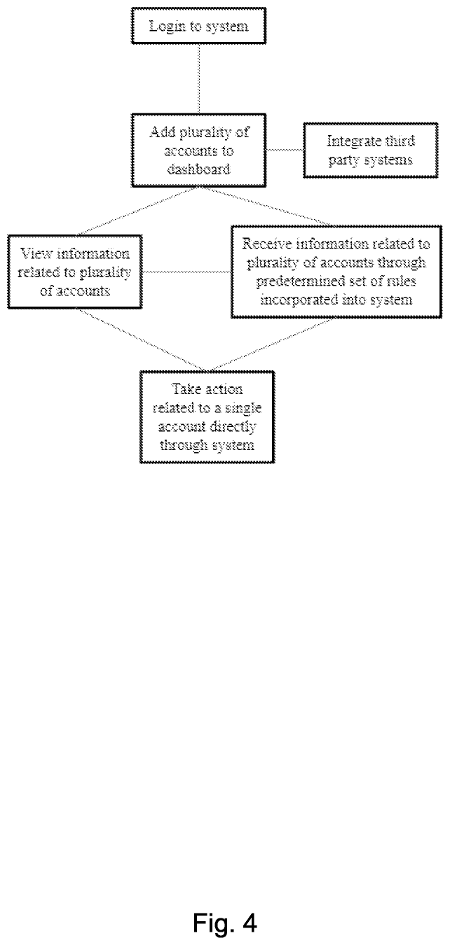

FIG. 5 is a diagram illustrating the self-employment system; the view showing one example of one task management system and various features of the task management system.

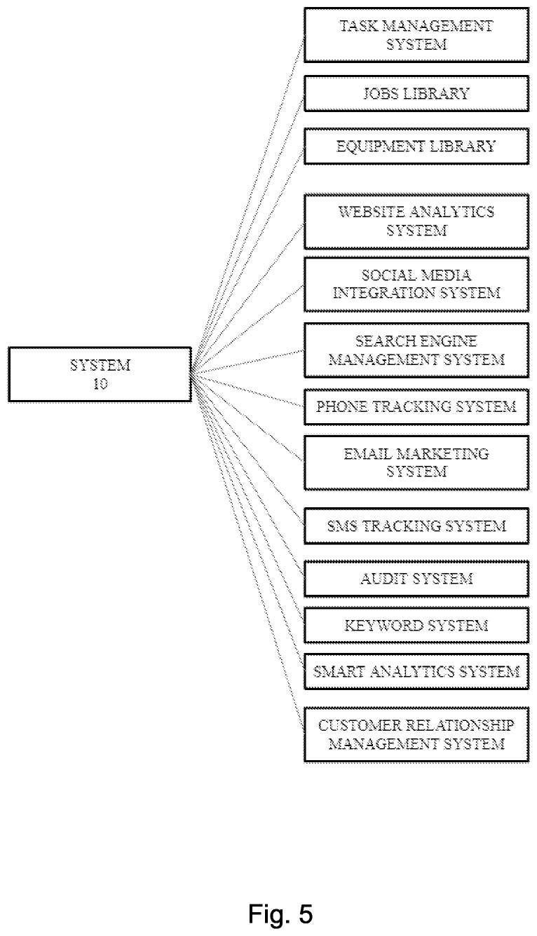

FIG. 6 is a diagram illustrating the self-employment system; the view showing one example of one embodiment of third party platform integrations with the system disclosed herein.

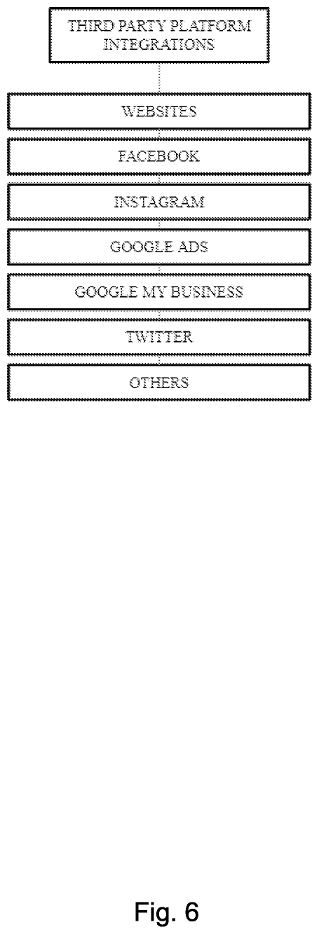

FIG. 7 is a diagram illustrating the self-employment system; the view showing one example of one embodiment of how a client and service provide may update and/or change the predetermined rules of the sort and search system disclosed herein for locating and/or offering hourly services.

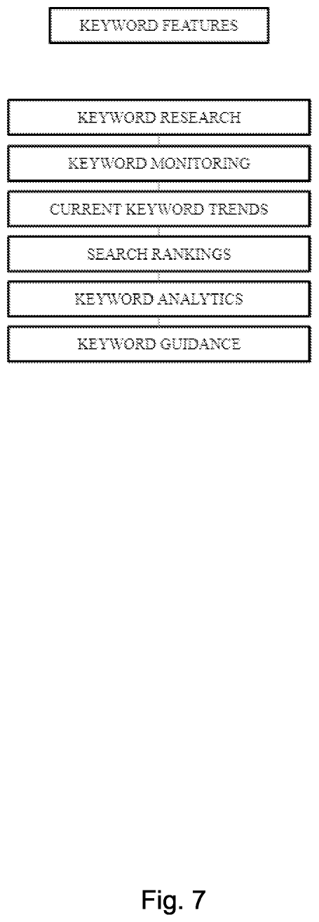

FIG. 8 is a diagram illustrating the self-employment system; the view showing one example of one embodiment of the task management system.

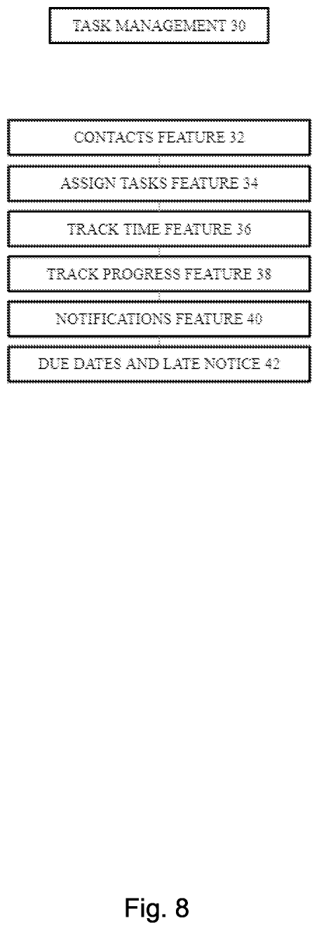

FIG. 9 is a diagram illustrating the self-employment system; the view showing one example of one embodiment of the equipment management system.

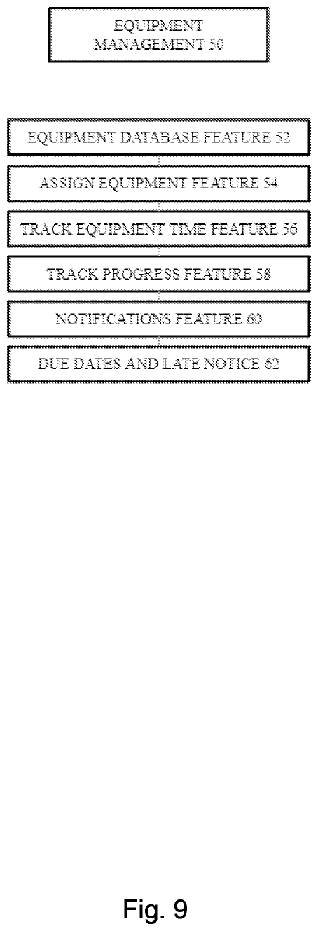

FIG. 10 is a diagram illustrating the self-employment system; the view showing various examples of engagement with the system by a client and/or service provider.

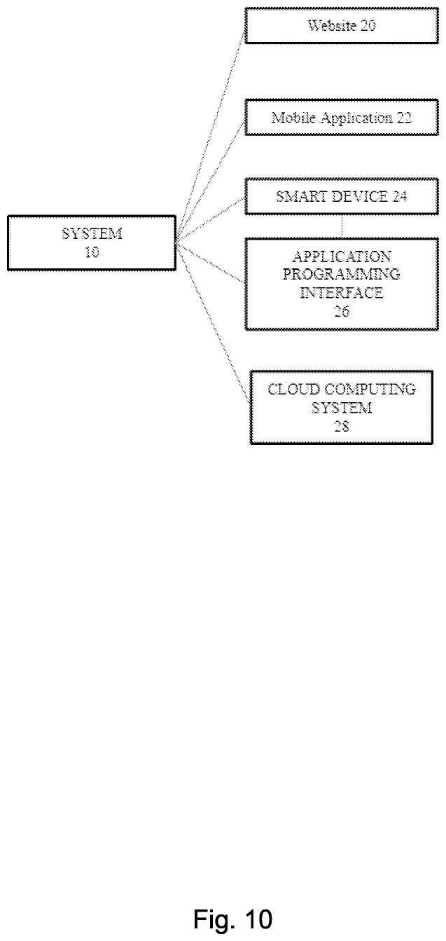

### DETAILED DESCRIPTION OF THE DISCLOSURE

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides and the like are referenced according to the views, pieces and figures presented. It should be understood, however, that the terms are used only for purposes of description, and are not intended to be used as limitations. Accordingly, orientation of an object or a combination of objects may change without departing from the scope of the disclosure.

Reference throughout this specification to “one embodiment,” “an embodiment,” “one example,” or “an example” means that a particular feature, structure, or characteristic described in connection with the embodiment or example is included in at least one embodiment of the present disclosure. Thus, the appearance of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium.

Any combination of one or more computer-usable or computer-readable media may be utilized. For example, a computer-readable medium may include one or more of a portable computer removable drive, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code, or virtual code, or framework code suitable for the disclosure herein, or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“Saas”), Platform as a Service (“PaaS”), and Infrastructure as a Service (“IaaS”)), and deployment models (e.g., private cloud, community cloud, public cloud, and hybrid cloud).

The flowchart and block diagrams in the attached figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

System:

With reference to the figures, an employment connection and self employment system and platform, process, and method of use 10 are presented. Employment platform system, process, and method of use 10 (hereafter referred to as “connection system”, “self employment system”, “service offering system”, “equipment rental system”, or simply “system”) is formed of any suitable size, shape and design.

In the arrangement shown, as one example, system 10 is configured to provide the state of the art with a connection system for connecting those in need of services or equipment to those providing services and/or equipment. More specifically, and without limitation, system 10 is configured to provide the state of the art with a system for hourly and/or daily contracting from individuals to individuals and/or groups to individuals. More specifically, and without limitation, system 10 is configured to provide the state of the art with rental services of equipment on hourly, daily, weekly, monthly, or yearly basis. More specifically, and without limitation, system 10 is configured to provide the state of the art with an employment opportunity system and methods of use.

In the arrangement shown, as one example, employment connection system 10 may comprise remote servers, databases, application servers, application databases, service databases, client databases, equipment databases, mobile applications, and/or computers; all of which in continuity or as separate acts fulfill the functions disclosed herein.

In the arrangement shown, as one example, the main structure of system 10 also includes a service provider 14, a client 16, an equipment 18, a website 20, a mobile application 22 or the like, a graphical user interface, and a computer, and a network, a computing system, a communication and/or control system, an application server, and a mobile computing application server, among other components, features, and functions, and functionality.

Service Provider (or Plurality Thereof):

In the arrangement shown, as one example, system 10 includes a service provider 14. Service provider 14 may be any provider interacting with or utilizing the system 10. This may include viewing, controlling, analyzing, manipulating, and/or interacting with system 10. Generally, a service provider is an individual offering some type of service through the platform 10. Service provider is not limited to a single user but may be a plurality of providers and/or a group of providers.

Client (or Plurality Thereof):

In the arrangement shown, as one example, system 10 includes a client 16. Client 16 may be any user interacting with or utilizing the system 10. This may include viewing, controlling, analyzing, manipulating, and/or interacting with system 10. Generally, a client 16 is a user of the platform 10 which is paying for and/or receiving a service. Client 16 may also be a user who is renting equipment and the like. Client 16 is not limited to a single user but may be a plurality of clients 16.

Equipment (or Plurality Thereof):

In the arrangement shown, as one example, system 10 may also include equipment 18. Equipment 18 may be any type of equipment from a broom to a backhoe, or computer equipment, or vehicular equipment, cleaning equipment, lawn care equipment, building and/or construction equipment and the like. Equipment, in some circumstances, may also include individuals and/or service providers to help run the equipment.

Graphical User Interface:

In the arrangement shown, as one example, system 10 may include a graphical user interface 12. Graphical user interface 12 (or service engagement platform) is formed of any suitable size shape and design and is configured to allow a user to view interact with, manipulate, and visually access the service offering and client access platform and system data and information, information related thereto, and/or view various data for various surfaces and/or environments and/or add information to a particular service offering database, job database, client database and platform system and/or equipment rental and/or add information about a piece of equipment and/or job data and/or change the settings of an account and/or profile and/or change the information related to any of the above.

Graphical user interface 12 is an exemplary method by which systems of the present disclosure may provide a means for a user to enter self employment and/or maintain self employment and/or advertise and/or make programming changes to the operation of system 10. Employing graphical user interface 12, enhances a user's interactions with system 10 in the form of awareness and knowledge of data within the system 10. System 10 provides direct links to a user's history, account, profile, settings, programming, and other information related to a particular service and/or a particular job and/or a particular client and/or a particular piece of equipment.

In this way graphical user interface 12 provides for a means for a user to make adjustments to the operation and functionality of system 10. Additionally, graphical user interface 12 provides direct interaction with the employment system, account parameters, service parameters, profile parameters, clients, jobs, and more. Additionally, local geographic information with relation to the system can be added, viewed, or retrieved.

Display of Graphical User Interface: In the arrangement shown, as one example, system 10 includes a graphical user interface 12. Graphical user interface 12 may include a display, which is configured to show and display information, including data, for review and interpretation by a user or plurality of users, or a plurality of users interacting with one another.

In the arrangement shown, as one example, an interactive user display is formed of a display screen, such as that of a smart device 24, such as desktop computer, laptop computer, monitor, tablet, smart phone, smart TV, projector, virtual reality display or any other device or form of a display. In the arrangement shown, as one example, interactive user display comprises a series of interactive user display pages, however, the interactive user display may consist of a single page or any other method of displaying information on a display as could be adapted to various size screens, devices, or user preferences. The interactive user display can display various patient and/or medical information which is retrieved and/or requested.

Task Management System:

In the arrangement shown, as one example, system 10 includes a task management system by which both clients and service providers can manage tasks which are offered, tasks which are assigned, tasks which are underway, and the like. The task management system 30 includes, but is not limited to, a contacts feature 32, an assign tasks feature 34, a track time feature 36, a track progress feature 38, a notifications feature 40, and a due dates and late notice feature 42.

Equipment Management System:

In the arrangement shown, as one example, system 10 includes an equipment management system by which both clients and service providers can manage equipment which are offered, equipment which are assigned, equipment which are engaged, and the like. The equipment management system 50 includes, but is not limited to, an equipment database feature 52, an assign equipment feature 54, a track time equipment feature 56, an equipment track progress feature 58, an equipment notifications feature 60, and an equipment due dates and late notice feature 62.

Computing Platform:

In the arrangement shown, as one example, system 10 includes a computing platform 300 (or “computer”, or “computer platform”). Computing platform is formed of any suitable size, shape, and design and is configured to provide computing support, power, and computing processing for both onboard computing functionality as well as communication for server computing functionality.

Computing device may be a single consolidated component, or alternatively, computing device may be formed of a plurality of interconnected components that may be co-located or located at different geographic locations. Computing devices may be cloud based or it may be hardware based, or cloud capable. In addition, the connected components of a computing device, including processor, memory, software and interactive user display, may be co-located with a computing device or located at different geographic locations and the like. That is, a computing device may be made of any form of a device or system that individually or collectively performs the computing operations of system 10.

Printed Circuit Board: In the arrangement shown, as one example, system 10 may include a printed circuit board (“PCB”). PCB is formed of any suitable size, shape and design and is configured to facilitate carrying and/or holding other components and/or parts necessary to carry out various computation and/or related functions of system 10. PCB, as one example, might be a surface mounted PCB or a through-hole PCB. PCB, as one example, is green and facilitates connecting the components and/or parts of system 10 by the use of traces and or vias. Traces are formed of any suitable size, shape and design and are configured as lines electrically connecting the components and/or parts of system 10. Vias are formed of any suitable size, shape and design and are configured as holes that connect layers of traces together. Generally, as in shown, traces and vias are soldered to connect the components and/or parts to the PCB.

Microprocessor: Microprocessor is any computing device that receives and processes information and outputs commands according to instructions stored in memory. Memory is any form of information storage such as flash memory, RAM memory, a hard drive, or any other form of memory. Memory may be included as a part of or operably connected to a microprocessor. A receiver/transceiver is connected to a microprocessor. A receiver is used if one way communication is utilized, whereas a transceiver is used if two-way communication is utilized (hereinafter “transceiver”). Receiver/transceiver is connected with an antenna, such as a monopole antenna, a loop antenna, a fractal antenna, or any other form of an antenna. Antenna receives wireless signals from any other device, transmits these signals to receiver/transceiver which processes these signals and then transmits these processed signals to microprocessor which processes these signals according to instructions stored in memory. In one arrangement, system 10 re-transmits operating commands signals through receiver/transceiver so as to similarly control over-the-air communication. Communication is any form of wireless signals, or wired signals, through the air, such as a conventional remote signal, a cell phone, a wireless device, an internet connected device, a hard-wired device, or any other device capable of transmitting remote control signals.

Memory: In the arrangement shown, as an example, system 10 includes a memory. Memory may be formed of any suitable size, shape and design and is configured to facilitate selective storage and retrieval of data (including data) in association with computing devices, processors, software and interactive user display. Memory may be a single component, such as a single chip or drive or other memory device, or alternatively memory may be formed of a plurality of memory or storage components that are connected to one another that may be co-located or located at different geographic locations.

Application Server:

In the arrangement shown, as one example, system 10 comprises remote servers or application programming interfaces 26, databases, and/or computers that fulfill the functions disclosed and described herein, specifically with respect to the employment application. In the embodiment depicted, system 10 comprises an application server. Application server comprises one or more computer systems adapted to transmit and receive data regarding selected datasets related to various users and/or datasets related to multiple users and/or jobs and/or service providers and/or clients and/or equipment rentals.

Application servers may transmit service provider data and/or job related documents with respect to a single service and/or job and/or multiple clients. Application server is also adapted to query a database. This query includes receiving and sending job identification and location data. Additionally, application servers may communicate with a cloud computing system 28 or a mobile application 22, which can also be adapted to present the data in a form conducive to being viewed on a mobile device and/or handheld device.

As one of ordinary skills in the art may understand, application server, database, and other databases mentioned herein may be implemented in one or more servers. Furthermore, each may be on multiple servers to increase system efficiency, especially when handling large data gathering, following extended guidelines, extended ranges, ranges discussed herein. Additionally, multiple servers may have mirrored data to prevent data loss in case of disk failure and/or to decrease access and response times for database queries. In alternative embodiments, application server, and other database procedures may be carried out on computer-readable instructions and data stored on the customer's mobile computing device.

In addition to the above identified features, options, controls, and components, system 10 may also include other features and functionalities, among other options, controls, and components.

It will be appreciated by those skilled in the art that other various modifications could be made to the system, process, and method of use without parting from the spirit and scope of this disclosure. All such modifications and changes fall within the scope of the claims and are intended to be covered thereby.

What is claimed:

1. A self-employment system, comprising:
a plurality of clients;
each of the plurality of clients having a plurality of jobs;
each of the plurality of jobs having a plurality of hours needed to fill;
a plurality of service providers;
each of the plurality of service providers offering a service;
each of the plurality of service providers having an area of expertise;
each of the plurality of service providers having available hours of service;
a writer;
wherein the writer sorts each of the plurality of jobs;
a queue;
wherein the queue presents the plurality of jobs in a predetermined order;
wherein a subsequent job of the plurality of jobs is populated on a list when each of the plurality of jobs of a current list of the plurality of jobs is filled with a relatable search criteria;
wherein at least one of the relatable search criteria is a criteria related to the area of expertise of the service provider;
a computing system;
the computing system having an application programming interface;
wherein the plurality of service providers offers services through the application programming interface;
wherein the plurality of clients locates and connects to the plurality of service providers through profiles of the plurality of service providers on the application programming interface;
the computing system having a graphical user interface.

2. The system of claim 1, further comprising:
a website through which a plurality of service providers create an account and a login to interact with others using the self-employment system.

3. The system of claim 1, further comprising:
a mobile application through which a plurality of service providers create an account and a login to interact with others using the self-employment system.

4. The system of claim 1, further comprising:
an equipment;
wherein the equipment is owned by one of the plurality of service providers;
wherein at least one of the plurality of clients desires to rent the equipment from one of the plurality of service providers.

5. The system of claim 1, further comprising:
a plurality of smart devices.

6. The system of claim 1, further comprising:
a plurality of smart devices;
wherein the plurality of clients access the computing system through the plurality of smart devices.

7. The system of claim 1, further comprising:
a plurality of smart devices;
wherein the plurality of service providers access the computing system through the plurality of smart devices.

8. The system of claim 1, further comprising:
a plurality of smart devices;
wherein the plurality of clients access the computing system through the plurality of smart devices;
wherein the plurality of service providers access the computing system through the plurality of smart devices.

9. The system of claim 1, further comprising:
a plurality of smart devices;
wherein at least one of the plurality of smart devices is a desktop computer.

10. The system of claim 1, further comprising:
a plurality of smart devices;
wherein at least one of the plurality of smart devices is a laptop computer.

11. The system of claim 1, further comprising:
a plurality of smart devices;
wherein at least one of the plurality of smart devices is a smart phone.

12. The system of claim 1, further comprising:
a task management system;
the task management system having a contacts feature;
the task management system having an assign task feature;
the task management system having a track time feature;
the task management system having a track progress feature;
the task management system having a notifications feature;
the task management system having a due date feature;
the task management system having a late notice feature.

13. The system of claim 1, further comprising:
a task management system;
the task management system having a contacts feature;
the task management system having an assign task feature;
the task management system having a track time feature;
the task management system having a track progress feature;
the task management system having a notifications feature;
the task management system having a due date feature.

14. The system of claim 1, further comprising:
a task management system;
the task management system having a contacts feature;
the task management system having an assign task feature;
the task management system having a track time feature;
the task management system having a track progress feature;
the task management system having a notifications feature.

15. The system of claim 1, further comprising:
a task management system;
the task management system having a contacts feature;
the task management system having an assign task feature;
the task management system having a track time feature;
the task management system having a track progress feature.

16. The system of claim 1, further comprising:
an equipment management system;
the equipment management system having an equipment database feature;
the equipment management system having an assign equipment feature.

17. The system of claim 1, further comprising:
an equipment management system;
the equipment management system having an equipment database feature;
the equipment management system having an assign equipment feature;
the equipment management system having a track equipment time feature;
the equipment management system having a track job progress feature;
the equipment management system having an equipment notifications feature.

18. The system of claim 1, further comprising:
an equipment management system;
the equipment management system having an equipment database feature;
the equipment management system having an assign equipment feature;
the equipment management system having a track equipment time feature;
the equipment management system having a track job progress feature;
the equipment management system having an equipment notifications feature;
the equipment management system having an equipment due date feature;
the equipment management system having an equipment late notice feature.

19. An equipment and job offering system.
a plurality of clients;
each of the plurality of clients having a plurality of jobs;
each of the plurality of jobs having a plurality of hours needed to fill;
a plurality of service providers;
each of the plurality of service providers offering a service;
each of the plurality of service providers having an area of expertise;
an equipment;
wherein the equipment is owned by one of the plurality of service providers;
wherein at least one of the plurality of clients desires to rent the equipment from one of the plurality of service providers;
a writer;
wherein the writer sorts each of the plurality of jobs;
a queue;
wherein the queue presents the plurality of jobs in a predetermined order;
wherein a subsequent job of the plurality of jobs is populated on a list when each of the plurality of jobs of a current list of the plurality of jobs is filled with a relatable search criteria;
wherein at least one of the relatable search criteria is a criteria related to the area of expertise of the service provider;
a computing system;
the computing system having an application programming interface;
wherein the plurality of service providers offers services through the application programming interface;
wherein the plurality of clients locates and connects to the plurality of service providers through profiles of the plurality of service providers on the application programming interface;
the computing system having a graphical user interface;
a plurality of smart devices;
wherein the plurality of clients access the computing system through the plurality of smart devices;
wherein the plurality of service providers access the computing system through the plurality of smart devices;
a task management system;
the task management system having a contacts feature;
the task management system having an assign task feature;
the task management system having a track time feature;
the task management system having a track progress feature;
the task management system having a notifications feature;
the task management system having a due date feature;
the task management system having a late notice feature;
an equipment management system;
the equipment management system having an equipment database feature;
the equipment management system having an assign equipment feature;
the equipment management system having a track equipment time feature;
the equipment management system having a track job progress feature;
the equipment management system having an equipment notifications feature;
the equipment management system having an equipment due date feature;
the equipment management system having an equipment late notice feature.

20. A method of offering an hourly service.
providing computing system;
providing an hourly service offering center through a computing platform system; the computing platform system having a plurality of clients, a plurality of service providers, an equipment;
providing a writer;
sorting each of the plurality of jobs by the writer into a queue;
wherein the queue presents the plurality of jobs in a predetermined order;
wherein a subsequent job of the plurality of jobs is populated on a list when each of the plurality of jobs of a current list of the plurality of jobs is filled with a relatable search criteria;
wherein at least one of the relatable search criteria is a criteria related to the area of expertise of the service provider;
the computing system having a graphical user interface;
providing a plurality of smart devices;
wherein the plurality of clients access the computing system through the plurality of smart devices;
wherein the plurality of service providers access the computing system through the plurality of smart devices;
providing a task management system;
the task management system having a contacts feature;
the task management system having an assign task feature;
the task management system having a track time feature;
the task management system having a track progress feature;
the task management system having a notifications feature;
the task management system having a due date feature;
the task management system having a late notice feature;
providing an equipment management system;
the equipment management system having an equipment database feature;
the equipment management system having an assign equipment feature;
the equipment management system having a track equipment time feature;
the equipment management system having a track job progress feature;
the equipment management system having an equipment notifications feature;
the equipment management system having an equipment due date feature;
the equipment management system having an equipment late notice feature.
